(19) United States
(12) Patent Application Publication
(10) Pub. No.: US 2004/0067772 A1
(43) Pub. Date: Apr. 8, 2004

(54) Method to inducing upgrading of a sim card

(76) Inventor: Serge Gaumain, Yverdon (CH)

Correspondence Address: Piper Rudnick, Supervisor Patent Prosecution Services, 1200 Nineteenth Street NW, Washington, DC, 20036-2412, US

(21) Appl. No.: 10/416,569

(22) PCT Filed: Nov. 12, 2001
(86) PCT No.: PCT/IB01/02128

(30) Foreign Application Priority Data
Nov. 13, 2000 (CH) 2000 2202/00

(51) Int. Cl. H04M 1/00

(52) U.S. Cl. 455/558

(57) ABSTRACT

The security modules (SIM cards) used in mobile telephones are called to evolve and thus to be replaced. In order to favour this replacement of a previous generation by a new one the method according to the invention consists in sending by a control centre in the data flux a replacement prompt command including the minimal characteristics of the SIM card of the new generation, establishing the characteristics of the SIM card being used, and comparing with the minimal characteristics defined by the received command, and according to the results of this comparison, starting a prompt cycle by sending an warning indication on the screen.

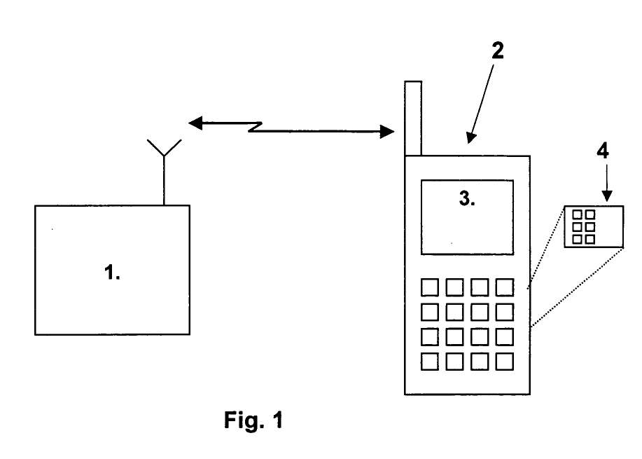

The present invention concerns a method for the updating of an evolutionary product, particularly in the field of SIM cards of mobile phones.

All the operators that use electronic and computer systems are faced with the updating of their products and the management of compatibility between the different versions. This matter is very important as the number of these products is very big and they are distributed on a large scale.

As these products are linked, even sporadically, to a management centre, the first approach of the operators has been to make this software modifiable by downloading. This technique has been possible thanks to the EEPROM or Flash memories that accept reprogramming and that do not need permanent powering.

In this way, when new functions appear, the downloading of the new software in these products allows the users to benefit from these functions without having to return their products to any technical centre.

In a one-way configuration, that is, a configuration in which only the link between the operator and the user is possible, it is difficult, even impossible, to determine if all the users have received the updating.

Thus, the operators are forced to assume the compatibility with several versions in parallel so that the users that have not received the updating can benefit from the proposed service.

This example can even be intensified when changing the generation of the product, that is, that a physical replacement of the product is necessary.

For this purpose the operators send the users the new generation of the product with the invitation of using this new product in the place of the previous one.

When it is an operator that proposes a payment service it is very difficult to impose the use of the new product suppressing all compatibility with the old product. This would provoke a dissatisfaction in the clients who feel little interest in considerations of a technical nature.

This is why the operators are at present constrained, out of fear of letting down their clients, to ensure not only the compatibility between the software versions, but also between the material generations. This compatibility is costly in pass-band terms when communicating with the products as the commands must be sent according to all the criteria of the different versions.

The objective of the present invention is a method that prompts the user to update his/her product when it is possible, and not when the centre ceases to support the version used by the user causing the stopping of the service.

This objective is achieved by a method consisting in determining the current version of the user's product and in comparing this version with the minimal intended version, and if the user's version is a previous one to the minimal version, producing a temporary visual prompt in the user's terminal.

According to one embodiment, the product is a smart card that controls the access to a mobile telephone of the GSM type also known as “cell phone”. This card allows to supply the necessary information to authorise access to the service, particularly to identify itself to the grantor of the service. This card, more commonly known as SIM, is connected to a mobile telephone. The process intended to convince the user to change his/her card is started by the control centre that sends, by the classical communication means, a prompt inviting to update the SIM card of the user.

Thus, according to the invention, the service given to the user is not interrupted but momentarily interfered in order to prompt the user to change his/her card for a more recent version.

According to a first embodiment, this interference or warning indication is carried out by adding a message on the screen of the mobile telephone during a short time in order to remind the user to change his/her card.

This apparition can be done on command of the card itself and be repeated. The frequency of repetition can vary in time so that the interference becomes annoying to the user. In this way for example from one apparition per day it will be increased to one apparition per hour if no action is taken by the user.

This warning indication is equally advantageously done when starting the mobile telephone.

Instead of a text message it is possible to add a pictogram, even a sequence of images describing the stages for changing the card.

According to one embodiment, this warning indication is not done in the form of a message but in the form of a simulation of a momentary reception breakdown. The reception indicator indicates the complete absence of reception during a short period, this operation being followed by adding the prompt message.

Another important aspect of the invention is the determination of the SIM card's version.

The control centre, in this type of setting, does not only send a target version number as a minimal condition to not interfere the user's screen. The centre can also condition this version to the presence of certain programmes in the database. The command sent to the mobile telephone is thus an intelligent command because the definition of the concerned card will be done according to the conditions comprised in the command. It is up to the card to determine if it fulfils the announced conditions in terms of data or programmes contained in its memory.

According to another embodiment, the control centre addresses nominatively the cards of the generation to be replaced because the centre has a database that inventories each type of SIM card in function. It is possible for it to determine itself the cards that need an updating. The control centre has means to address each card nominatively to order it the stopping of the changing prompt process. This process can be interrupted either by the effective changing of the card or on command of the control centre.

Other forms of warning indication, for example sonorous, can also be used in the range of this invention.

The single FIGURE illustrates the system according to the invention that comprises a control centre 1 linked with one or several mobile telephones composed of a keyboard, a screen 3 and a SIM card 4. The SIM card 4 is assembled in a moveable way inside the telephone 2. It is true that the exchange is not foreseen to be carried out by the user, this is why the message sent to the screen 3 may contain the address of the nearest place where such an exchange can take place. In fact, the particularity of these telephones is that they are connected to a local relay that knows the nearest technical centre. This address is added to the prompt message added preferentially during opening hours of the technical centre.

An embodiment of the invention consists in including in the updating prompt message an information indicating the user that he/she will benefit from certain advantages or supplementary services after changing the SIM card. These advantages can be for example in the form of a supplementary credit, free minutes of conversation, or an extension of the subscription period.

The updating of the SIM card is detected by the control centre that receives the data of the new card. The control centre then transmits the necessary data to the SIM card allowing the introduction of the advantages or supplementary services.

According to another embodiment the changing of the SIM card is not detected by the control centre. The flux of data transmitted by the latter then contains specific data destined to the new SIM card that comprises functions apt to supply the advantages to the user. A variation of this implementation is possible with the introduction of granting conditions of supplementary services in the SIM card. Since its starting it checks the access conditions giving the right to these supplementary services, and if these conditions are fulfilled according to these services. They can have the form for example of a conversation credit during a limited time of one month.

1. A method to favour the replacement of a SIM card of a previous generation for that of a new generation in a cell phone connected in which is assembled the SIM card and receiving a flux of data from at least one control centre defining a plurality of services, said cell phone comprising at least one screen, characterised in that it consists in:
sending by the control centre in the data flux a replacement prompt command including the minimal characteristics of the SIM card of new generation;
establishing the characteristics of the SIM card being used and comparing with the minimal characteristics defined in the received command, and according to the results of the comparison,
starting a prompt cycle by sending a warning indication to the screen.

2. A method according to claim 1, characterised in that the warning indication is done in the form of a text message on all or part of the screen.

3. A method according to claim 2, characterised in that the warning indication contains information relating to the granting of supplementary services transmitted by the control centre, this granting being determined according to the replacement conditions of the SIM card.

4. A method according to claim 1, characterised in that the warning indication is done in the form of one or several graphical images on all or part of the screen.

5. A method according to claims 1 to 4, characterised in that this warning indication is accompanied by a sonorous signal, in a musical or verbal form.

6. A method according to claims 1 to 5, characterised in that the control centre determines the nearest technical centre to the cell phone and includes the address of this centre in the message sent to the cell phone.

7. A method according to any of the preceding claims, characterised in that the warning indication is reproduced according to a determined cycle.

8. A method according to claim 1, characterised in that when introducing a new SIM card, the latter comprises means to transmit a start message to the control centre containing replacement conditions, said control centre granting access to supplementary services.

9. A method according to claim 1, characterised in that the data flux transmitted by the control centre contains specific messages destined to authorise access to one or several supplementary services only if the SIM card is updated.

10. A method according to claim 1, characterised in that the SIM card contains data relating to the granting conditions of supplementary services, since its starting, said SIM card checks the access conditions to the supplementary services and grants these supplementary services only if the granting conditions are fulfilled.
